(19) United States
(12) Patent Application Publication
(10) Pub. No.: US 2002/0048262 A1
(43) Pub. Date: Apr. 25, 2002

(54) Method and system for assigning node numbers to network nodes in a network

(76) Inventor: Geert Fieremans, Boca Raton, FL (US)

Correspondence Address: BELL, BOYD & LLOYD, LLC, P. O. BOX 1135, CHICAGO, IL, 60690-1135, US

(21) Appl. No.: 09/955,237

(22) Filed: Sep. 17, 2001

(30) Foreign Application Priority Data
Sep. 19, 2000 (DE) 100 46 311.8

(51) Int. Cl. H04L 12/28

(52) U.S. Cl. 370/254; 370/426

(57) ABSTRACT

A method and system for assigning node numbers to network nodes in a network, the network being connected to a central device performing administration of the node numbers available for the network, wherein cases in which a request message is received at the central device, the central device ascertains a free node number from the available node numbers and transmits the ascertained node number to an appropriate network node.

### BACKGROUND OF THE INVENTION

Communication networks and computer networks include network nodes, for example, formed by communications installations and data processing devices, as well as the connecting lines connecting the individual network nodes to one another. In this context, a multiplicity of different network structures (also referred to in the literature as network topologies) are known, such as a star network, a ring network, a tree network, a chain network or a bus network.

In networks, a distinction is drawn between connectionless and connection-oriented networks, according to the topology of the respective network. Connectionless networks omit a signaling phase which precedes information transmission between communication terminals associated with the networks and within the context of which a connection is set up between the communication terminals. In a connectionless network, for example, an IP-oriented (Internet Protocol) computer network, an information packet to be transmitted is transmitted to each communication terminal associated with the network. The decision regarding which communication terminal processes the received information packet further or rejects it is made by the recipient of the information packet.

In a connection-oriented network, for example an ISDN-oriented communication network, information is transmitted from network node to network node via a connection set up previously within the context of a signaling connection. In this case, the individual network nodes in the network are addressed using node numbers, generally formed by an integer value. To be able to ensure unique addressing, it is necessary for the respective node numbers in the network to be unique. In cases in which the node numbers are not unique, it is no longer possible to guarantee selective deliveries of messages via the network.

In this context, the node numbers associated with the network nodes in the network are generally administered by a service technician or network administrator directly at the respective network node or centrally from a service center. This method is associated with a high level of complexity, however, depending on the size of the network.

The present invention is, therefore, directed toward providing a method and system which permit node numbers to be assigned to network nodes in a network more conveniently.

### SUMMARY OF THE INVENTION

Accordingly, in an embodiment of the present invention, a method is provided for assigning node numbers to network nodes in a network, wherein: the network is connected to a central device performing administration of the node numbers available for the network; a request message is transmitted to the central device; the central device ascertains a free node number from the available node numbers; and the ascertained node number is transmitted and assigned to a network node.

In an embodiment, the request message is transmitted from a network node which has not yet been assigned a node number to the central device in cases in which the network node is being newly registered on the network.

In an embodiment, in cases in which the central device is not active at the instant at which the network node is registered, node-specific data are administered locally by the network node and, when the central device has been activated, these locally administered data are brought into line with the central device and updated.

In an embodiment, the request message is transmitted to the central device in the cases in which a change needs to be made for the already assigned node numbers.

In an embodiment, a newly assigned node number is accepted by a network node only in cases in which the central device is authorized to assign node numbers.

In an embodiment, the request message is transmitted from a network node to the central device in the cases in which the network node has previously received a polling message from the device, and the network node has not yet been assigned a node number.

In an embodiment, within the context of the polling message, node-specific information is additionally transmitted from the network node to the central device.

In an embodiment, the request message and/or the polling message are transmitted via a temporary signaling connection within the network.

In a further embodiment of the present invention, a system is provided for assigning node number to networks nodes in a network, which includes: a central device for administering the node numbers available for the network; and a local communication unit at at least one of the network nodes for the purposes of communicating with the central device, the local communication unit being able to be used to assign a free node number ascertained by the central device within the context of a request message to a network node.

In an embodiment, the central device is connected to one of the network nodes in the network via a local area network.

A fundamental advantage of the inventive method and of the inventive system is that node numbers are assigned to network nodes in a network automatically from a central device, resulting in the level of complexity for assignment being kept to a minimum. At the same time, the susceptibility to errors which is associated with manual input of a large number of data is reduced, wherein it is possible to reduce the likelihood of an identical node number being allocated to two or more network nodes, and hence the transmission quality within the network is increased.

One advantage of refinements of the present invention is, among other things, that transmitting messages for assignment of node numbers and for the purposes of ascertaining already allocated node numbers via a signaling connection, in particular a D-channel of an ISDN-oriented connect, within the network (frequently referred to in the literature as “Temporary Signaling Connection,” TSC for short) takes up only a small amount of transmission capacities within the network, and additionally no charges arise either.

Additional features and advantages of the present invention are described in, and will be apparent from, the following Detailed Description of the Invention and the Figures.

### BRIEF DESCRIPTION OF THE FIGURES

FIG. 1 shows a structogram for schematically illustrating an exemplary network.

FIG. 2 shows a flowchart to illustrate the fundamental method steps of the present invention carried out for assigning a node number.

FIG. 3a shows a first flowchart to illustrate the fundamental method steps of the present invention carried out for ascertaining the network topology.

FIG. 3b shows a second flowchart to illustrate the fundamental method steps of the present invention carried out for ascertaining the network topology.

### DETAILED DESCRIPTION OF THE INVENTION

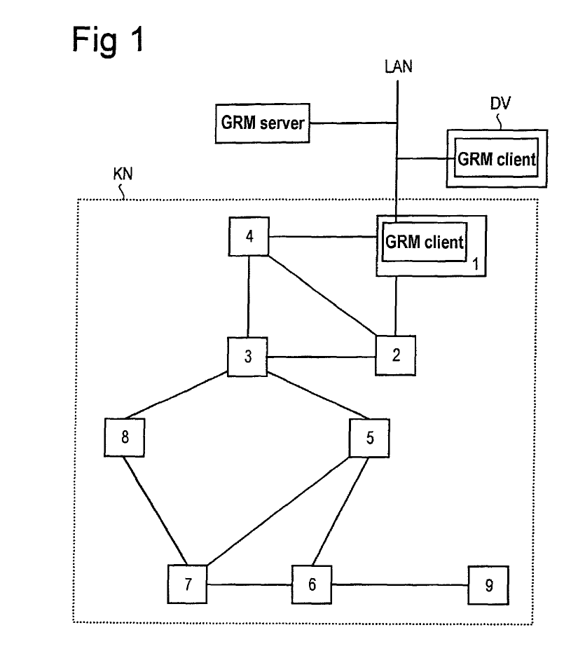

FIG. 1 shows a structogram for an exemplary network KN, in particular a connection-oriented network, which is used to illustrate the inventive method below. In this case, the network KN is an ISDN-oriented communication network, for example. The network KN includes a total of nine network nodes 1, . . . , 9, which are interconnected with one another in the manner shown. In this case, the network KN has a series of annular and chain-like network structures. A network node 1, . . . , 9 can be produced, by way of example, by a communications installation or, alternatively, by an appropriately designed data processing device; e.g., a personal computer or a workstation.

The network KN is connected to a local area network LAN via a first network node 1. In this context, data are transmitted via the local area network LAN on the basis of the IP protocol (Internet Protocol). Connected to the local area network LAN is a data processing device DV, for example. In addition, a “GRM server” (Global Routing Manager) is connected to the local area network LAN and, in the present exemplary embodiment, is used for central administration of node numbers NODE-ID for the network nodes 1, . . . , 9 in the network KN.

Administration of the node numbers NODE-ID associated with the network nodes 1, . . . , 9 in the network KN requires that the GRM server receive information about which network nodes 1, . . . , 9 within the network KN are active; i.e., are registered on the network KN. For communication with the GRM server, the first network node 1 therefore has a communication unit (frequently referred to in the literature as GRM client) which can be used for exchanging information between the GRM server and the network nodes 1, . . . , 9.

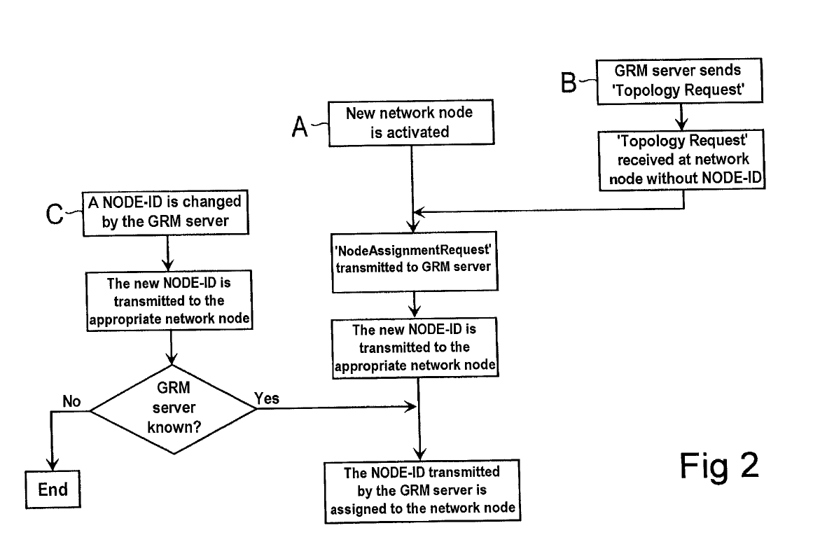

FIG. 2 shows, on the basis of three different initial situations A, B, C, a flowchart to illustrate the fundamental method steps carried out for assigning a node number NODE-ID to a network node 1, . . . , 9 in the network KN.

On the basis of a first initial situation A, a new network node 1, . . . , 9 in the network KN is activated; i.e., the network node 1, . . . , 9 is registered on the network KN. This network node 1,...,9 then sends a request message “NodeAssigmnentRequest” to the GRM server via the first network node 1, the request message being used by the network node 1, . . . , 9 to request that a node number NODE-ID be assigned. The first network node 1 converts the ISDN-protocol-based request message “NodeAssignmentRequest” received via the network KN into a corresponding IP-protocol based message and sends the message to the GRM server via the local area network LAN. The GRM server then ascertains a free node number NODE-ID from the node numbers NODE-ID available for the network KN and transmits this free node number via the first network node 1 to that network node 1, . . . , 9 which transmitted the request message “NodeAssignmentRequest” to the GRM server. The network node 1, . . . , 9 thus has the transmitted node number 1, . . . , 9 assigned to it until the network node 1, . . . , 9 is deactivated on the network KN.

In cases in which the GRM server is not active at the instant at which the network node 1, . . . , 9 is activated, the network node 1, . . . , 9 locally administers a default node number and other node-specific data used for data transmission via the network KN until the GRM server is activated. After an activation operation, the local data are brought into line with the GRM server and are updated.

On the basis of a second initial situation B, the GRM server sends a polling message via the local area network LAN. The first network node 1 receiving the polling message converts the IP-protocol-based message into a corresponding ISDN-protocol-based polling message “Topology Request” and sends the polling message “Topology Request” via the network KN. If a network node 1, . . . , 9 which previously has not been assigned a node number NODE-ID now receives the polling message “Topology Request,” this network node 1, . . . , 9 sends a request message “NodeAssignmentRequest” to the GRM server, which request message is used by the network node 1, . . . , 9 to request that a node number NODE-ID be assigned. The method is then continued in a similar manner to those method steps described for the initial situation A.

Within the context of such a polling message “Topology Request” initialized by the GRM server, it is possible to poll both the node number NODE-ID assigned to a network node 1, . . . , 9 in the network KN and other node-specific information. In this case, the node-specific information includes, by way of example, a “node name”, a node address assigned to the network node 1, . . . , 9 in the network KN, information about the node type (e.g., a communications installation or a data processing device), information about a call number plan stored at a network node 1, . . . , 9 (particularly in a communications installation) or about an LCR scheme (Least Cost Routing) stored at the network node 1, . . . , 9.

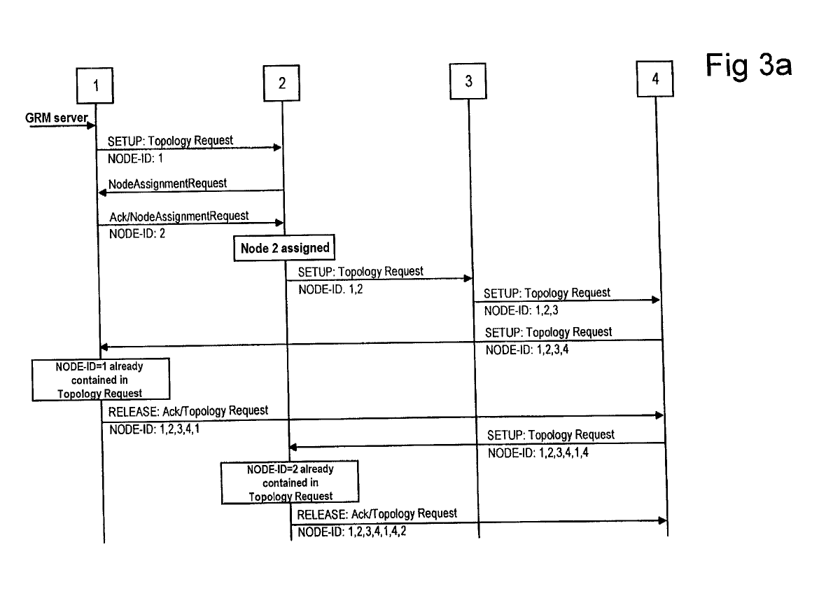

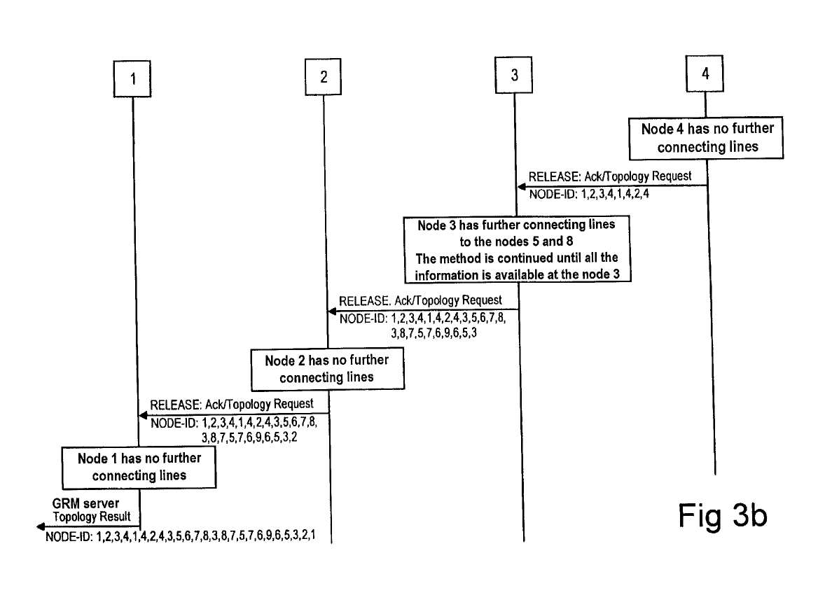

Such a polling message “Topology Request” provides the option of storing all information about the network KN centrally on the GRM server. Storing all network-specific information in a central device makes it possible to ensure efficient administration of the network KN from the GRM server. By way of example, the communication processed in the network KN in order to ascertain the network topology, i.e., to ascertain the node numbers already allocated in the network KN, is illustrated with reference to FIGS. 3a and 3b.

On the basis of a third initial situation C, the GRM server centrally changes the node numbers NODE-ID already allocated in the network KN. The first network node 1, receiving from the GRM server an appropriate message assigning a new node number NODE-ID to a network node 1, . . . , 9, converts the IP-protocol-based message into a corresponding ISDN-protocol-based message and sends this message to the appropriate network node 1, . . . , 9 via the network KN. The network node 1, . . . , 9 carries out a check to determine whether the GRM server sending the message is known at the network node 1, . . . , 9; i.e., is authorized to change the node number NODE-ID. If this is the case, the new node number NODE-ID is assigned to the network node 1, . . . , 9.

To illustrate the second initial situation B, in which the GRM server sends a polling message, FIG. 3 (including FIG. 3a and FIG. 3b) with FIG. 3b directly following FIG. 3a, shows a flowchart to illustrate the fundamental method steps carried out when ascertaining the network nodes 1, . . . , 9 active or registered on the network KN. For the present exemplary embodiment, only the first four network nodes 1, . . . , 4 in the network KN are shown. In addition, it is assumed that the network nodes 1, 3, . . . , 9 in the network KN already have been assigned a node number NODE-ID, with the exception of the second network node 2.

To ascertain the network topology from the GRM server, the GRM server sends a polling message via the local area network LAN to the first network node 1, or to the GRM client arranged at the first network node 1. The first network node 1, or the GRM client at the first network node 1, converts the IP-protocol-based request message into the ISDN protocol and sends a polling message “SETUP: Topology Request, NODE-ID: 1” to a network node 2,4 connected to the first network node 1 (in the present exemplary embodiment to the second network node 2). Since the second network node 2 in the network KN has not yet been assigned a node number NODE-ID, this network node sends a request message “NodeAssignmentRequest” to the first network node 1. The first network node 1 then ascertains by accessing the GRM server, a free node number NODE-ID (in the present exemplary embodiment the node number NODE-ID=2) and sends an appropriate response message “Ack/NodeAssignmentRequest NODE-ID:2” to the second network node 2. The second network node 2 has thus been assigned the node number NODE-ID=2.

In a next step, the second network node 2 enters its node number NODE-ID=2 into the polling message and sends a message “SETUP: Topology Request, NODE-ID: 1, 2” to one of the network nodes 3, 4 connected to the second network node 2 (in the present exemplary embodiment, to the third network node 3). This network node enters its node number NODE-ID=3 into the polling message and sends a message “SETUP: Topology Request, NODE-ID: 1, 2, 3” to one of the network nodes 4, 5, 8 connected to the third network node 3 (in the present exemplary embodiment, to the fourth network node 4). The fourth network node 4, in turn, enters its node number NODE-ID=4 into the polling message and sends a message “SETUP: Topology Request, NODE-ID: 1, 2, 3, 4” to one of the network nodes 1, 2 connected to the fourth network node 4 (in the present exemplary embodiment, to the first network node 1).

The first network node 1 recognizes that its node number NODE-ID=1 already has been entered in the polling message. The first network node 1 then enters its node number NODE-ID=1 into the polling message again and sends a message “RELEASE: Ack/Topology Request, NODE-ID: 1, 2, 3, 4, 1” back to the fourth network node 4. This network node enters its node number NODE-ID=4 into the polling message again and sends a message “SETUP: Topology Request, NODE-ID: 1, 2, 3, 4, 1, 4” to the network node 2 not selected previously. The second network node 2 likewise recognizes that its node number NODE-ID=2 already has been entered in the polling message and then enters its node number NODE-ID=2 into the polling message and sends a message “RELEASE: Ack/Topology Request, NODE-ID: 1, 2, 3, 4, 1, 4, 2” back to the fourth network node 4.

The fourth network node 4, thus, has no further connecting lines. It enters its node number NODE-ID=4 into the polling message again and sends a message “RELEASE: Ack/Topology Request, NODE-ID: 1, 2, 3, 4, 1, 4, 2, 4” back to the third network node 3, from which it originally received the polling message. Unlike the fourth network node 4, the third network node 3 has further connecting lines, not yet taken into account, to the network nodes 5 and 8 and continues the method with the method steps described. In this context, the method is continued until all the information about the subnetwork including the network nodes 3, 5, 6, 7, 8, 9 is available at the third network node 3.

The third network node thus has no further connecting lines. It then enters its node number NODE-ID=3 into the polling message again and sends a message “RELEASE: Ack/Topology Request, NODE-ID: 1, 2, 3, 4, 1, 4, 2, 4, 3, 5, 6, 7, 8, 3, 8, 7, 5, 7, 6, 9, 6, 5, 3” back to the second network node 2, from which it originally received the polling message. The second network node thus likewise has no further connecting lines not yet taken into account. It enters its node number NODE-ID=2 into the polling message and sends a message “RELEASE: Ack/Topology Request, NODE-ID: 1, 2, 3, 4, 1, 4, 2, 4, 3, 5, 6, 7, 8, 3, 8, 7, 5, 7, 6, 9, 6, 5, 3, 2” back to the first network node 1, from which it originally received the polling message. The first network node thus likewise has no further connecting lines not yet taken into account. It then enters its node number NODE-ID=1 into the polling message and finally, sends a message “GRM server: Topology Result, NODE-ID: 1, 2, 3, 4, 1, 4, 2, 4, 3, 5, 6, 7, 8, 3, 8, 7, 5, 7, 6, 9, 6, 5, 3, 2, 1” to the GRM server. The GRM server stores the network topology information, obtained via the polling message, in an appropriate manner, for example in tabular form. A method for showing the network topology of the network KN using the information obtained in the form of the node numbers NODE-ID already has been proposed in the German patent application having the in-house application identifier 2000 15779.

The messages for the polling message and for the request message are transmitted via a signaling connection (frequently referred to in the literature as “Temporary Signaling Connection”, TSC for short) in the network KN; for example, a D-channel of an ISDN connection. In this way, only a small amount of transmission capacities are used within the network KN, and no additional charges arise for ascertaining the network topology.

Although the present invention has been described with reference to specific embodiments, those with skill in the art will recognize that changes may be made thereto without departing from the spirit and scope of the invention as set forth in the hereafter appended claims.

1. A method for assigning node numbers to network nodes in a network, the method comprising the steps of:
connecting the network to a central device performing administration of the node numbers available for the network;
transmitting a request message to the central device;
ascertaining a free node number from available node numbers via the central device; and
transmitting and assigning the ascertained node number to a network node.

2. A method for assigning node numbers to network nodes in a network as claimed in claim 1, wherein the request message is transmitted from a network node which has not yet been assigned a node number to the central device if the network node is being newly registered on the network.

3. A method for assigning node numbers to network nodes in a network as claimed in claim 2, the method further comprising the steps of:
administering node-specific data locally by the network node if the central device is not active at an instant at which the network node is registered; and
bringing into line and updating the locally administered data when the central device has been activated.

4. A method for assigning node numbers to network nodes in a network as claimed in claim 1, wherein the request message is transmitted to the central device if a change needs to be made for the already assigned node number.

5. A method for assigning node numbers to network nodes in a network as claimed in claim 4, wherein a newly assigned node number is accepted by a network node only if the central device is authorized to assign node number.

6. A method for assigning node numbers to network nodes in a network as claimed in claim 1, wherein the request message is transmitted from a network node to the central device if the network node previously has received a polling message from the central device, and the node has not yet been assigned a node number.

7. A method for assigning node numbers to network nodes in a network as claimed in claim 6, the method further comprising the step of:
transmitting node-specific information from the network node to the central device within the context of the polling message.

8. A method for assigning node numbers to network nodes in a network as claimed in claim 1, wherein at least one of the request message and the polling message are transmitted via a temporary signaling connection within the network.

9. A system for assigning node numbers to network nodes in a network, comprising:
a central device for administering the node number available for the network; and
a local communication unit at at least one of the network nodes for communicating with the central device, the local communication unit able to assign a free node number ascertained by the central device within the context of a request message to a network node.

10. A system for assigning node number to network nodes and a network as claimed in claim 9, wherein the central device is connected to one of the network nodes in the network via a local area network.
